(19) United States
(12) Patent Application Publication
(10) Pub. No.: US 2022/0064940 A1
(43) Pub. Date: Mar. 3, 2022

(54) FIRE-RETARDANT WEBBED APPARATUS

(71) Applicant: David A. Homan, Candler, NC (US)

(72) Inventor: David A. Homan, Candler, NC (US)

(21) Appl. No.: 17/412,938

(22) Filed: Aug. 26, 2021

Related U.S. Application Data
(60) Provisional application No. 63/070,407, filed on Aug. 26, 2020.

(51) Int. Cl. E04B 1/94; A62C 3/02; A62C 35/68

(52) U.S. Cl. CPC E04B 1/94; A62C 35/68; A62C 3/0292

(57) ABSTRACT

A fire-retardant webbed apparatus for use on a structure includes at least one tube surrounding a channel; at least one inlet port on the at least one tube, the at least one inlet port being in fluid flow communication with the channel, and the at least one inlet port being sized and configured for receiving a flow of fluid; a plurality of apertures formed along the length of the one or more tubes, the plurality of apertures each being in fluid flow communication with the channel; and wherein the flow of a fluid into the channel through a selected one of the at least one inlet ports causes the fluid to be emitted through plurality of apertures onto the structure and surrounding area for preventing the spread of fire onto the structure.

### CROSS REFERENCE TO RELATED APPLICATION

This application claims priority to U.S. Provisional Patent Application Ser. No. 63/070,407 filed on Aug. 26, 2020, entitled “Fire-Retardant Webbed Apparatus,” the disclosure and drawing of which are hereby incorporated herein in their entirety by reference.

### BACKGROUND

Estimates for the annual costs associated with suppressing wildfires exceed $1 billion. To minimize the damage from wildfires, people often burn smaller fires to minimize the amount of flammable material available for a potential wildfire to expand. For practical reasons and as wildfires have become more prevalent, such preparation is not always feasible. Accordingly, there exists a need for a webbed apparatus, such as for, but not limited to, preventing the spread of fire onto a structure.

### SUMMARY

A fire-retardant webbed apparatus for use on a structure, as disclosed herein, includes at least one tube surrounding a channel; at least one inlet port on the at least one tube, the at least one inlet port being in fluid flow communication with the channel, and the at least one inlet port being sized and configured for receiving a flow of fluid; a plurality of apertures formed along the length of the one or more tubes, the plurality of apertures each being in fluid flow communication with the channel; and wherein the flow of a fluid into the channel through a selected one of the at least one inlet ports causes the fluid to be emitted through plurality of apertures onto the structure and surrounding area for preventing the spread of fire onto the structure.

A fire-retardant webbed apparatus for use on a structure, as disclosed herein, includes at least one tube surrounding a channel; at least one inlet port on the at least one tube, the at least one inlet port being in fluid flow communication with the channel, and the at least one inlet port being sized and configured for receiving a flow of fluid; a plurality of apertures formed along the length of the one or more tubes, the plurality of apertures each being in fluid flow communication with the channel; a plurality of water jets along the length of the at least one tube, the plurality of water jets each being in fluid flow communication with the channel; and wherein the flow of a fluid into the channel through a selected one of the at least one inlet ports causes the fluid to be emitted through plurality of apertures and projected by the plurality of water jets onto the structure and surrounding area for preventing the spread of fire onto the structure.

### BRIEF DESCRIPTION OF THE DRAWING

For a fuller understanding of the nature of the present invention, reference should be made to the following detailed description, taken in conjunction with the accompanying drawings in which:

FIG. 1 is a perspective view of the webbed apparatus on a building structure.

FIG. 2 is a perspective view of the webbed apparatus in accordance with an embodiment.

FIG. 3 is an isolated view of the webbed apparatus illustrating the interlaced tubing in accordance with an embodiment.

Like reference numerals refer to like parts throughout the several Figures of the drawing.

### DETAILED DESCRIPTION

The webbed apparatus of the present invention is shown in accordance with one embodiment and is generally referred to as 10.

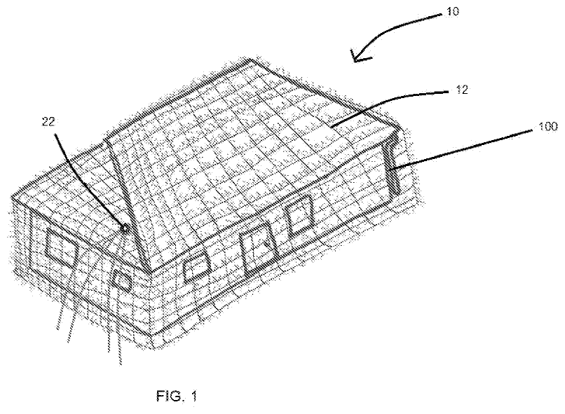

FIG. 1 shows the webbed apparatus 10 on a structure 100. A fluid is being emitted from the apparatus 10 in order to prevent the spread of a fire onto the structure 100. While the apparatus 10 is shown in use with a structure 100 that is a building, the apparatus 10 may also be used on other structures, such as trees, shrubbery and automobiles, as well.

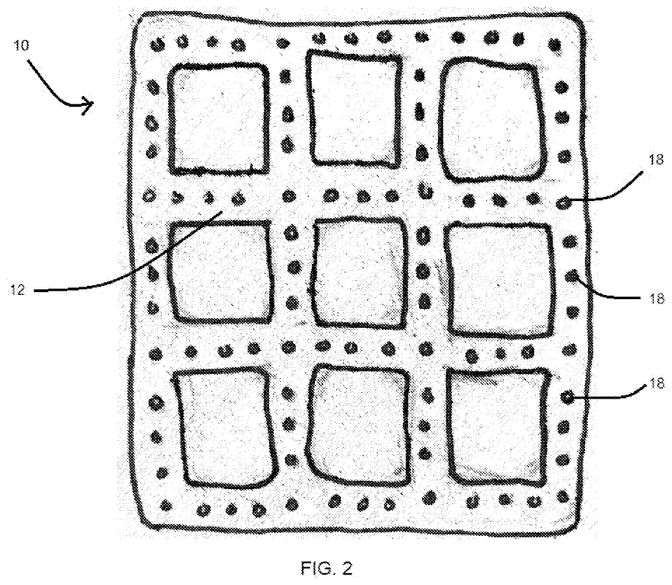

FIG. 2 is a perspective view of the webbed apparatus 10. In accordance with an embodiment, the apparatus 10 includes one or more tubes 12 each surrounding a channel 14. The channels 14 are in fluid flow communication which each other such that introduction of water (or other fluid, hereinafter collectively referred to as “water”) through an inlet port 16 causes the water to flow through the one or more channels 14. A plurality of apertures 18 are formed along the length of the one or more tubes 12, each of the apertures 18 extending from an outer surface 20 of the tubes 12 to the channel 14, such that the water is emitted therefrom, as shown in FIG. 1.

In an embodiment, the apparatus 10 includes a combination of tubing 12 and netting, wherein the tubing 12 is affixed to the netting.

In an embodiment, the apertures 18 are mist ports.

In an embodiment, one or more water jets 22 may be built in along the tubing 12 for projecting the water further than the water pressure alone would permit.

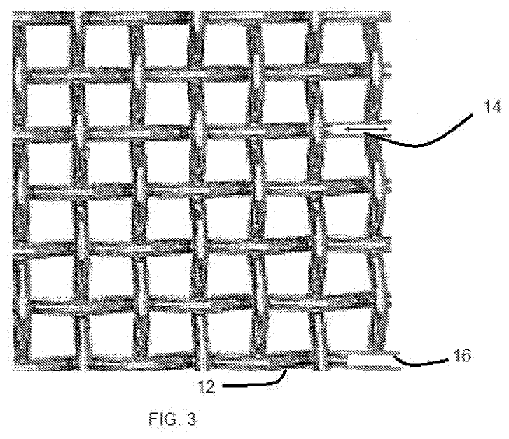

Referring now to FIG. 3, the one or more tubes 12 are shown in an interlaced configuration. The interlaced configuration of the tubes 12 provides stability for the apparatus 10 and further permits easier use thereof.

A fire-retardant webbed apparatus for use on a structure, as disclosed herein, comprises:

at least one tube surrounding a channel;

at least one inlet port on the at least one tube, the at least one inlet port being in fluid flow communication with the channel, and the at least one inlet port being sized and configured for receiving a flow of fluid;

a plurality of apertures formed along the length of the one or more tubes, the plurality of apertures each being in fluid flow communication with the channel; and

wherein the flow of a fluid into the channel through a selected one of the at least one inlet ports causes the fluid to be emitted through plurality of apertures onto the structure and surrounding area for preventing the spread of fire onto the structure.

A fire-retardant webbed apparatus for use on a structure, as disclosed herein, comprises:

at least one tube surrounding a channel;

at least one inlet port on the at least one tube, the at least one inlet port being in fluid flow communication with the channel, and the at least one inlet port being sized and configured for receiving a flow of fluid;

a plurality of apertures formed along the length of the one or more tubes, the plurality of apertures each being in fluid flow communication with the channel;

a plurality of water jets along the length of the at least one tube, the plurality of water jets each being in fluid flow communication with the channel; and

wherein the flow of a fluid into the channel through a selected one of the at least one inlet ports causes the fluid to be emitted through plurality of apertures and projected by the plurality of water jets onto the structure and surrounding area for preventing the spread of fire onto the structure.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

The subject matter described herein is provided by way of illustration only and should not be construed as limiting the nature and scope of the subject invention. While examples of aspects of the subject invention have been provided above, it is not possible to describe every conceivable combination of components or methodologies for implementing the subject invention, and one of ordinary skill in the art may recognize that further combinations and permutations of the subject invention are possible. Furthermore, the subject invention is not necessarily limited to implementations that solve any or all disadvantages which may have been noted in any part of this disclosure. Various modifications and changes may be made to the subject invention described herein without following, or departing from the spirit and scope of, the exemplary embodiments and applications illustrated and described herein. Although the subject matter presented herein has been described in language specific to components used therein, it is to be understood that the subject invention is not necessarily limited to the specific components or characteristics thereof described herein; rather, the specific components and characteristics thereof are disclosed as example forms of implementing the subject invention. Accordingly, the disclosed subject matter is intended to embrace all alterations, modifications, and variations, that fall within the scope and spirit of any claims that are written, or may be written, for the subject invention.

What is claimed is:

1. A fire-retardant webbed apparatus for use on a structure, the apparatus comprising:
at least one tube surrounding a channel;
at least one inlet port on the at least one tube, the at least one inlet port being in fluid flow communication with the channel, and the at least one inlet port being sized and configured for receiving a flow of fluid;
a plurality of apertures formed along the length of the one or more tubes, the plurality of apertures each being in fluid flow communication with the channel; and
wherein the flow of a fluid into the channel through a selected one of the at least one inlet ports causes the fluid to be emitted through plurality of apertures onto the structure and surrounding area for preventing the spread of fire onto the structure.

2. The fire-retardant webbed apparatus as recited in claim 1 wherein the plurality of apertures comprises a plurality of mist ports.

3. The fire-retardant webbed apparatus as recited in claim 1 further comprising at least one water jet built in along the at least one tube.

4. The fire-retardant webbed apparatus as recited in claim 1 wherein the at least one tube comprises a plurality of tubes.

5. The fire-retardant webbed apparatus as recited in claim 4 wherein the plurality of tubes is in an interlaced configuration.

6. A fire-retardant webbed apparatus for use on a structure, the apparatus comprising:
at least one tube surrounding a channel;
at least one inlet port on the at least one tube, the at least one inlet port being in fluid flow communication with the channel, and the at least one inlet port being sized and configured for receiving a flow of fluid;
a plurality of apertures formed along the length of the one or more tubes, the plurality of apertures each being in fluid flow communication with the channel;
a plurality of water jets along the length of the at least one tube, the plurality of water jets each being in fluid flow communication with the channel; and
wherein the flow of a fluid into the channel through a selected one of the at least one inlet ports causes the fluid to be emitted through plurality of apertures and projected by the plurality of water jets onto the structure and surrounding area for preventing the spread of fire onto the structure.

7. The fire-retardant webbed apparatus as recited in claim 6 wherein the plurality of apertures comprises a plurality of mist ports.

8. The fire-retardant webbed apparatus as recited in claim 6 further comprising at least one water jet built in along the at least one tube.

9. The fire-retardant webbed apparatus as recited in claim 6 wherein the at least one tube comprises a plurality of tubes.

10. The fire-retardant webbed apparatus as recited in claim 9 wherein the plurality of tubes is in an interlaced configuration.
